(19) United States
(12) Patent Application Publication
(10) Pub. No.: US 2017/0279937 A1
(43) Pub. Date: Sep. 28, 2017

(54) METHOD AND DEVICE FOR TRANSLATION BETWEEN IPV4 AND IPV6

(71) Applicant: Sanechips Technology Co., Ltd., Shenzhen, Guangdong (CN)

(72) Inventors: Sheng Shi, Shenzhen (CN); Quan Sun, Shenzhen (CN); Junhua Yan, Shenzhen (CN)

(21) Appl. No.: 15/504,123

(22) PCT Filed: Nov. 18, 2014
(86) PCT No.: PCT/CN2014/091430

§ 371 Date: Feb. 15, 2017

(30) Foreign Application Priority Data
Aug. 22, 2014 (CN) 201410419646.3

(51) Int. Cl. H04L 29/06; H04L 29/12; H04L 12/749

(52) U.S. Cl. CPC H04L 69/167; H04L 45/741; H04L 61/251; H04L 12/4633

(57) ABSTRACT

A method for the translation between IPv4 and IPv6 is disclosed, including: a BIH link tracker and quick translator are provided in a network core and when a link is established between an IPv4 client and IPv6 server, a standard translator translates and sends to the IPv6 server, a packet sent from the IPv4 client to the IPv6 server, and the

BIH link tracker extracts and records information on link and translation of the IPv4 client and IPv6 server from the packet for interaction therebetween; and during a process of sending the packet after establishing the link between the IPv4 client and IPv6 server, the packet is sent to the quick translator which translates and sends the packet according to the information on the translation corresponding to the information on the link recorded by the BIH link tracker. A device for the translation between IPv4 and IPv6 is also disclosed.

### TECHNICAL FIELD

The disclosure relates to a technology for the transition from IPv4 to IPv6, and in particular, to a method and a device for the translation between IPv4 and IPv6.

### BACKGROUND

With the development of services and network scales of mobile Internets and the Internet of things, IPv4 addresses which are used widely have become a scare resource. To deal with the shortage of IPv4 addresses, the Internet Engineering Task Force (IETF) has proposed an IPv6 addressing mode.

IPv6, which is a new generation of network protocol, adopts a 128-bit address format, providing a tremendously huge address space to completely solve the problem of the shortage of IPv4 addresses. After more than ten years of research, experience and industrial promotion, IPv6 has currently come into a stage of commercial deployment,

Technologies for the transition from IPv4 to IPv6 are mainly industrially classified into three types: dual stack, tunnel and translation.

1. IPv4/IPv6 Dual Stack Technology A dual-stack node uses an IPv4 protocol stack when communicating with an IPv4 node and uses an IPv6 protocol stack when communicating with an IPv6 node.

2. Tunnel Technology

A technology is provided which realizes the communication connection between two IPv6 sites through an IPv4 network and the communication connection between two IPv4 sites through an IPv6 network.

3. Technology for Translation Between IPv4 and IPv6

A technology is provided for the mutual access of an IPv4 network and an IPv6 network.

China mobile advocates the ideal of migrating IP traffic to IPv6 and proposes an innovative IPv6 transition technology (PNAT, Prefix based NAT) which employs a host-based translation mechanism of Bump in Host (BIH) which realizes the migration of service traffic to IPv6, PNAT/BIH supports the transparent running of IPv4-supporting applications on an IPv6 network and is capable of realizing the free communication between an IPv4 network and an IPv6 network.

The BIH technology proposed by China mobile belongs to an IPv4-IPv6 translation technology included in IPv6 transition technologies. The BIH technology whose prototype system has been developed and for which technical standards are formulated is currently filed in RFC6535.

But this technology has certain shortcomings in specific implementation. Each packet has to go through both an IPv4 procedure and an IPv6 procedure. Especially for systems such as linux system, an IPv4 procedure and an IPv6 procedure both include a great number of HOOK functions. It is revealed by the test of the realization of BIH in a linux system with the source codes issued by China mobile that the processing of a packet consumes much time, the performance of BIH is poor and user experience is deteriorated.

### SUMMARY

To address the technical problems existing in the conventional art, embodiments of the disclosure are intended to provide a method and a device for the translation between IPv4 and IPv6.

To achieve the purposes above, the solutions of the disclosure are as follows.

In an embodiment of the disclosure, a method for the translation between IPv4 and IPv6 is provided which includes:

a BIH link tracker and a quick translator are provided in a network core, and when a link is established between an IPv4 client and an IPv6 server, a standard translator translates a packet sent from the IPv4 client to the IPv6 server and then sends the translated packet to the IPv6 server, and the BIH link tracker extracts information on the link and translation of the IPv4 client and the IPv6 server from the packet for interaction between the IPv4 client and the IPv6 server and records the extracted information; and during a process of sending the packet after the establishment of the link between the IPv4 client and the IPv6 server, a packet is sent to the quick translator, and the quick translator translates the packet according to the information on the translation corresponding to the information on the link recorded by the BIH link tracker and then sends the translated packet.

In an embodiment of the disclosure, a device for the translation between IPv4 and IPv6 is provided. The device includes a BIH link tracker, a standard translator and a quick translator.

The BIH link tracker is arranged to extract, when a link is established between an IPv4 client and an IPv6 server, information on the link and translation of the IPv4 client and the IPv6 server from the packet for interaction between the IPv4 client and the IPv6server and record the extracted information.

The standard translator is arranged to translate a packet sent from the IPv4 client to the IPv6 server and send the translated packet to the IPv6 server.

The quick translator is arranged to translate, during a process of sending the packet after the establishment of the link between the IPv4 client and the IPv6 server, a packet according to the information on the translation corresponding to the information on the link recorded by the BIH link tracker and then send the translated packet.

According to the method and the device for the translation between IPv4 and IPv6provided herein, a BIH link tracker and a quick translator are provided in a network core. When a link is established between an IPv4 client and an IPv6 server, a packet sent from the IPv4 client to the IPv6 server is translated by a standard translator and then sent to the IPv6 server. The BIH link tracker extracts the information on the link and translation of the IPv4 client and the IPv6 server from the packet for interaction between the IPv4 client and the IPv6 server and records the extracted information. During a process of sending the packet after the establishment of the link between the IPv4 client and the IPv6 server, a packet is sent to the quick translator. The quick translator translates the packet according to the information on the translation corresponding to the information on the link recorded by the BIH link tracker and then sends the translated packet. In this way, the information on the link and the information on the translation are recorded by an added BIH link tracker, and a subsequent packet can be directly translated by the quick translator and sent if the information on the link of the packet is recorded in the BIH link tracker. Thus, the method and the device for the translation between IPv4 and IPv6 can solve the problems that existing BIH technology is time-consuming in processing and a bit poor in performance.

### BRIEF DESCRIPTION OF THE DRAWINGS

FIG. 1 is a schematic diagram illustrating a network architecture for the translation between an IPv4 network and an IPv6 network;

FIG. 2 is a schematic diagram illustrating a network architecture for the translation between IPv4 and IPv6 realized in an embodiment of the disclosure;

FIG. 3 is a flowchart illustrating a method for the translation between IPv4 and IPv6 realized in an embodiment of the disclosure;

FIG. 4 is a schematic diagram illustrating the transmission of a packet from IPv4 to IPv6 during a link establishment process provided in an embodiment of the disclosure;

FIG. 5 is a schematic diagram illustrating the transmission of a packet from IPv6 to IPv4 during a link establishment process provided in an embodiment of the disclosure;

FIG. 6 is a schematic diagram illustrating the transmission of a packet from IPv4 to IPv6 after the establishment of a link provided in an embodiment of the disclosure;

FIG. 7 is a schematic diagram illustrating the transmission of a packet from IPv4 to IPv6 after the establishment of a link provided in an embodiment of the disclosure; and

FIG. 8 is a schematic diagram illustrating the structure of a device for the translation between IPv4 and IPv6 realized in an embodiment of the disclosure.

### DETAILED DESCRIPTION

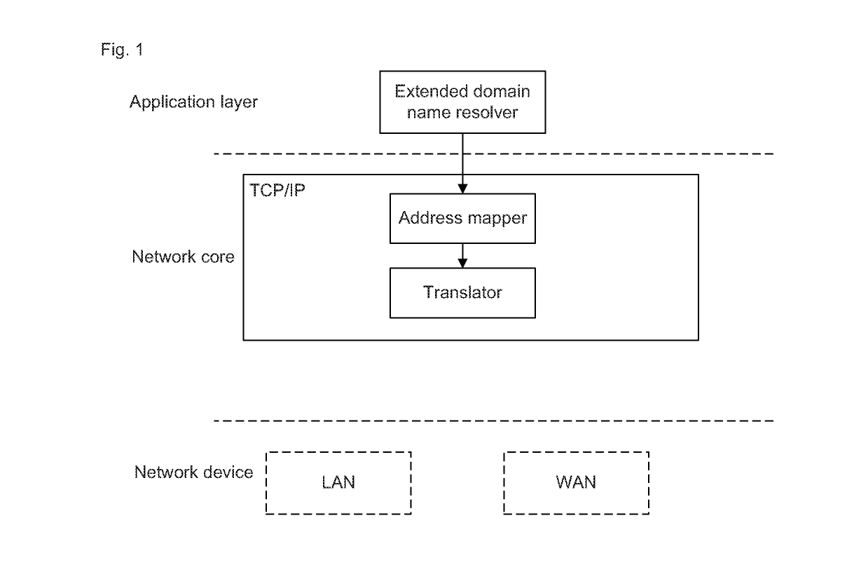

In the BIH technology, the translation between an IPv4 network and an IPv6 network is realized by an application layer and a network core. As shown in FIG. 1, the application layer includes an extended domain name resolver, and the network core includes an address mapper and a translator. In case of a DNS request of an Intranet terminal, if the extended domain name resolver fails to request an A-class Domain Name Service (DNS) (to request for an IPv4 address), then the extended domain name resolver constructs an AAAA-class request (to request for an IPv6 address) and sends the AAAA-class request to a DNS server. When an IPv6 address is obtained, the extended domain name resolver calls a core interface, applies to the address mapper for a virtual IPv4 address and returns the virtual IPv4 address to the intranet terminal. At the same time, the address mapper records the mapping relationship between the IPv6 address and the virtual IPv4 address. For a packet for which a link is established between the intranet terminal and the server (TOP three-way handshake, the first mutual interaction of UDP), if a match with an IP address mapping table is succeeded, then the packet enters the translator to be subject to an IPv4->IPv6 translation or an IPv6->IPv4 translation.

In embodiments of the disclosure, a BIH link tracker and a quick translator are set in a network core. When a link is established between an IPv4 client and an IPv6 server, a packet sent from the IPv4 client to the IPv6 server is translated by a standard translator and then the translated packet is sent to the IPv6 server. The BIH link tracker extracts information on the link of the IPv4 client and the IPv6 server and information on the translation of the IPv4 client and the IPv6 server from the packet for interaction between the IPv4 client and the IPv6 server. When the link between the IPv4 client and the IPv6 server is established, during a process of sending the packet, a packet is sent to the quick translator, and the quick translator translates the packet according to the information on the translation corresponding to the information on the link recorded by the BIH link tracker and then sends the translated packet.

The disclosure is described below in detail with reference to specific embodiments in conjunction with accompanying drawings.

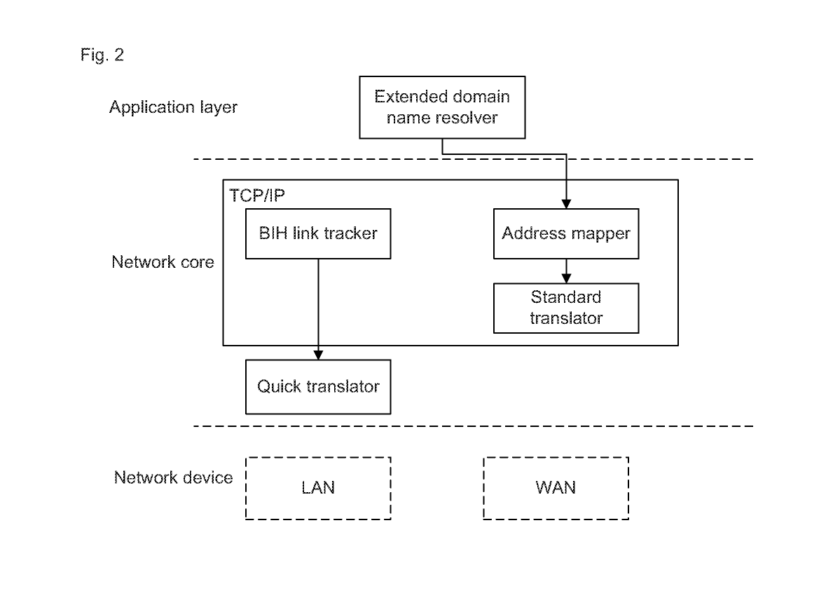

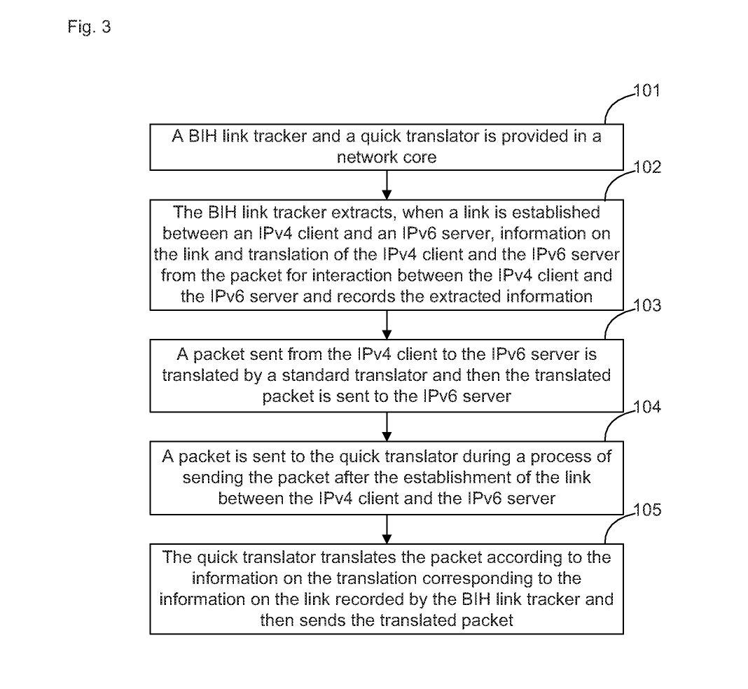

In an embodiment of the disclosure, a method for the translation between IPv4 and IPv6 is realized which. As shown in FIG. 2 and FIG. 3, the method mainly includes the following steps.

In step 101, a BIH link tracker and a quick translator are provided in a network core.

In step 102, the BIH link tracker extracts, when a link is established between an IPv4client and an IPv6 server, information on the link and translation of the IPv4 client and the IPv6 server from the packet for interaction between the IPv4 client and the IPv6 server and records the extracted information.

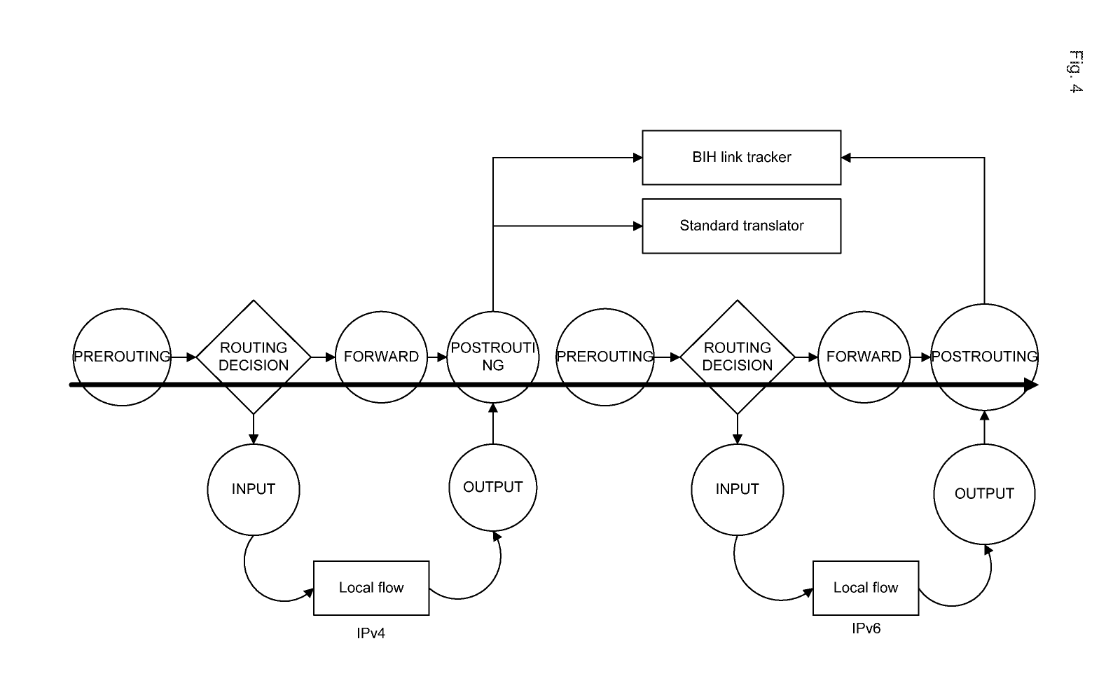

Specifically, when the IPv4 client initiates the establishment of a link to the IPv6 server, as shown in FIG. 4, a translation device receives a packet sent from the IPv4 client. Then the translation device sends the packet to the BIH link tracker when carrying out POSTROUTING for the packet, and the BIH link tracker extracts, from the packet, information on the link of the IPv4 client and information on forward and backward translation of the IPv4 client and records the extracted information.

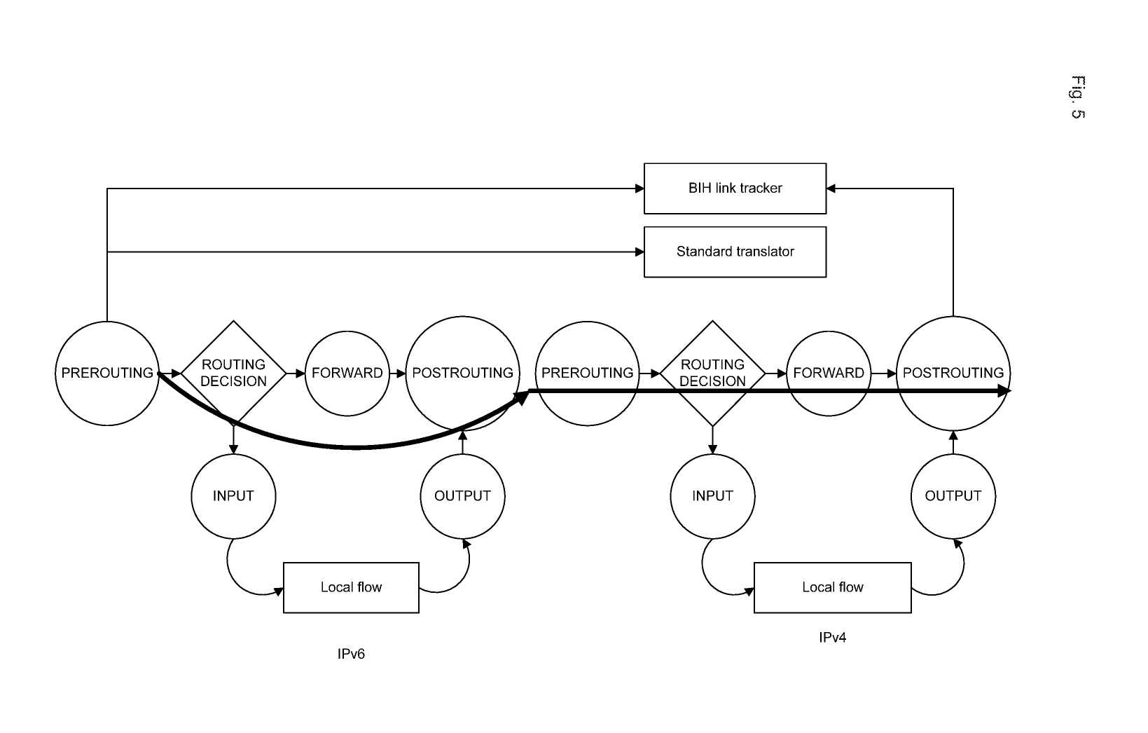

When the IPv6 server returns a response to the establishment of the link to the IPv4 client, as shown in FIG. 5, the translation device receives a packet sent from the IPv6 server. The translation device sends the packet to the BIH link tracker when carrying out PREROUTING for the packet, and the BIH link tracker extracts, from the packet, the information on the link of the IPv6 server and the information on the forward and backward translation and records the extracted information.

The extraction refers to an extraction from fields of a packet head. The information on the forward and the backward translation include: a source IP address, a target IP address, a source MAC address, a target MAC address, a port of a source network device, a port of a target network device and the like.

In step 103, a packet sent from the IPv4 client to the IPv6 server is translated by a standard translator and then the translated packet is sent to the IPv6 server.

Specifically, the translation device sends the packet sent from the IPv4 client to the IPv6 server to the standard translator. The standard translator translates, according to an IP address mapping table sent from an address mapper, the packet from an IPv4 type to an IPv6 type and then sends the translated packet to the IPv6 server.

In step 104, after the establishment of the link between the IPv4 client and the IPv6 server, during a process of sending the packet, a packet is sent to the quick translator.

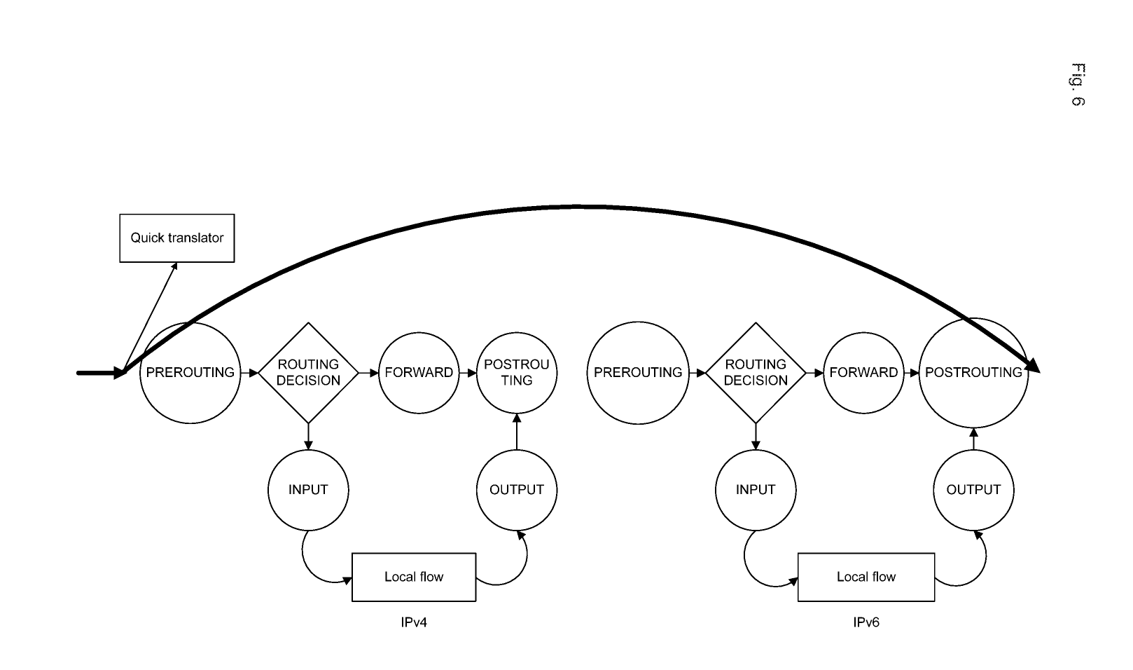

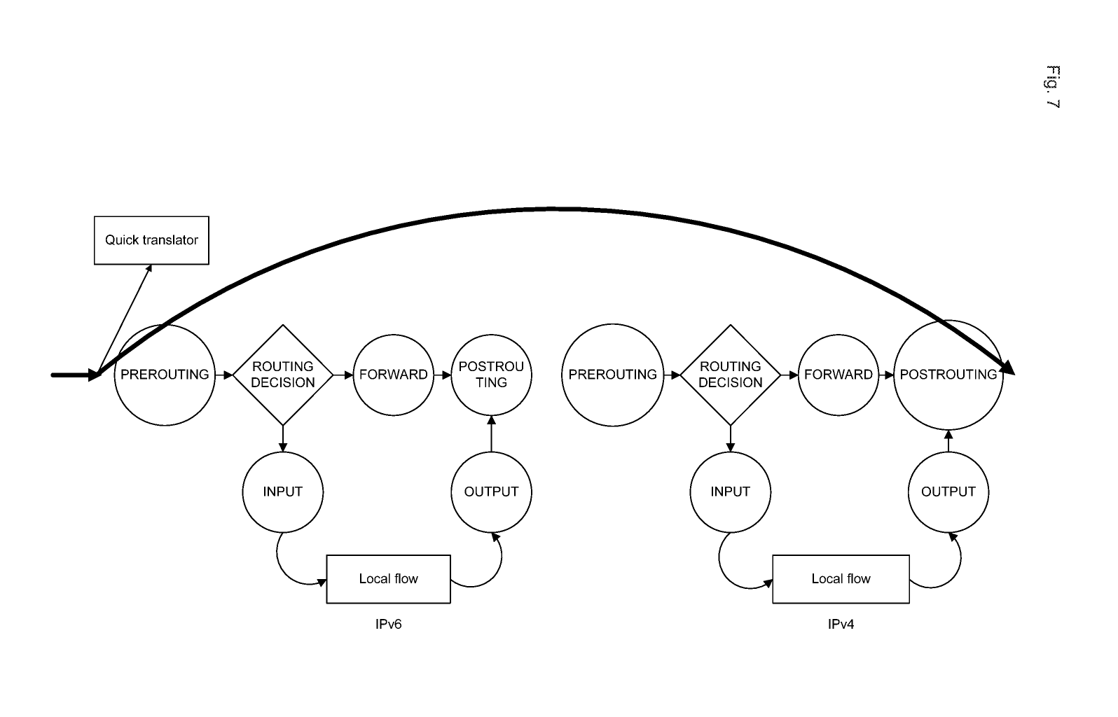

Specifically, after a link is established between an IPv4 network and an IPv6 network, when the IPv4 client initiates the transmission of data to the IPv6 server, as shown in FIG. 6, the translation device sends a packet to the quick translator before carrying out PREROUTING for the packet; and when the IPv6 initiates the transmission of data to the IPv4 client, as shown in FIG. 7, the translation device sends the packet to the quick translator before carrying out PREROUTING for the packet.

In step 105, the quick translator translates the packet according to the information on the translation corresponding to the information on the link recorded by the BIH link tracker and then sends the translated packet.

Specifically, the quick translator extracts the information on the link of the IPv4 client from the packet, matches the information on the link with the information on the link recorded by the BIH link tracker. When the matching is succeeded, the quick translator translates the packet from an IPv4 type to an IPv6 type according to the information on the forward and backward translation corresponding to the matched information on the link and then sends the translated packet to the IPv6 server.

Alternatively, the quick translator extracts the information on the link of the IPv6 server from the packet, matches the information on the link with the information on the link recorded by the BIH link tracker. When the matching is succeeded, the quick translator translates the packet from an IPv6 type to an IPv4 type according to the information on the forward and backward translation corresponding to the matched information on the link and then sends the translated packet to the IPv4 client.

As shown in FIG. 6, after finding, from the information on the link recorded by the BIH link tracker, link information matched with the information on the link included in the packet, the BIH link tracker translates the packet from an IPv4 type to an IPv6 type directly according to the information on the forward and backward translation corresponding to the matched information on the link and then sends the translated packet to the IPv6 server.

As shown in FIG. 7, after finding, from the information on the link recorded by the BIH link tracker, link information matched with the information on the link included in the packet, the BIH link tracker translates the packet from an IPv6 type to an IPv4 type according to the information on the forward and backward translation corresponding to the matched information on the link and then sends the translated packet to the IPv4 client.

It can be seen from FIG. 6 and FIG. 7 that a packet can be directly sent to an opposite terminal by completely bypassing the PREROUTING, the ROUTING DECISION, the FORWARD and the POSTROUTING that need to be carried out by the translation device. As such, a great amount of processing time is saved and transmission efficiency can be improved.

In the method, the following steps are included prior to step 101. After an A-class DNS request for a domain name is failed, an extended domain name resolver constructs an AAAA-class DNS request for a domain name. The extended domain name resolver calls a core interface after obtaining an IPv6 address, and applies to the address mapper for a virtual IPv4 address and returns the virtual IPv4 address to the IPv4 client. The address mapper records the mapping relationship between the IPv6 address and the virtual IPv4 address in an IP address mapping table, and sends the IP address mapping table to the standard translator.

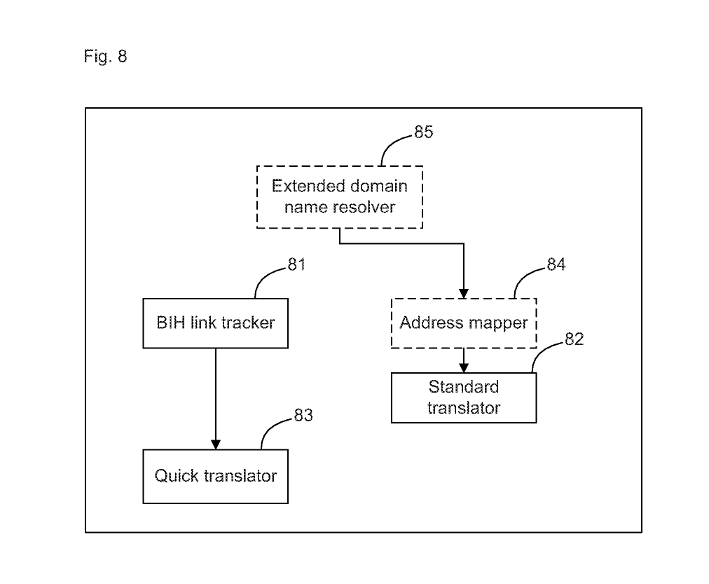

To realize the foregoing method, in an embodiment of the disclosure, a device for the translation between IPv4 and IPv6 is provided. The device is arranged in a translation device such as a router or an exchanger. As shown in FIG. 8, the device includes a BIH link tracker 81, a standard translator 82 and a quick translator 83.

The BIH link tracker 81 is arranged to extract, when a link is established between an IPv4 client and an IPv6 server, information on the link and translation of the IPv4 client and the IPv6 server from the packet for interaction between the IPv4 client and the IPv6 server, and record the extracted information.

The standard translator 82 is arranged to translate a packet sent from the IPv4 client to the IPv6 server, and send the translated packet to the IPv6 server.

The quick translator 83 is arranged to translate, during a process of sending the packet after the establishment of the link between the IPv4 client and the IPv6 server, a packet according to the information on the translation corresponding to the information on the link recorded by the BIH link tracker and then send the translated packet.

When the IPv4 client initiates the establishment of a link to the IPv6 server, the BIH link tracker 81 is specifically arranged to, when carrying out POSTROUTING for the packet sent from the IPv4 client, extract, from the packet sent from the IPv4 client, information on the link of the IPv4 client and information on forward and backward translation of the IPv4 client, and record the extracted information.

When the IPv6 server serving as a client returns a response to the establishment of the link to the IPv4 client, the BIH link tracker 81 is specifically arranged to, when carrying out PREROUTING for a packet sent from the IPv6 server, extract, from the packet sent from the IPv6 server, information on the link of the IPv6 server and the information on the forward and backward translation of the IPv6 server, and record the extracted information.

The information on the forward and the backward translation include: a source IP address, a target IP address, a source MAC address, a target MAC address, a port of a source network device, a port of a target network device and the like.

The quick translator 83 is specifically arranged to extract the information on the link of the IPv4 client from a packet, and match the information on the link with the information on the link recorded by the BIH link tracker 81. The quick translator 83 is arranged to, when the matching is succeeded, translate the packet from an IPv4 type to an IPv6 type according to the information on the forward and backward translation corresponding to the matched information on the link, and send the translated packet to the IPv6 server. Alternatively, the quick translator 83 is arranged to extract the information on the link of the IPv6 server from the packet, and match the information on the link with the information on the link recorded by the BIH link tracker 81. The quick translator 83 is arranged to, when the matching is succeeded, translate the packet from an IPv6 type to an IPv4 type according to the information on the forward and backward translation corresponding to the matched information on the link, and send the translated packet to the IPv4 client.

The standard translator 82 is specifically arranged to translate, according to an IP address mapping table sent from an address mapper, a packet from an IPv4 type to an IPv6 type, and send the translated packet to the IPv6 server.

Accordingly, the device further includes an address mapper 84 which is arranged to send the IP address mapping table to the standard translator 82.

After a link is established between an IPv4 network and an IPv6 network, the quick translator 83 is specifically arranged to, before carrying out PREROUTING, match the information on the link in a packet with the information on the link recorded by the BIH link tracker 81. The quick translator 83 is arranged to, when the matching is succeeded, translate the packet from an IPv4 type to an IPv6 type directly according to the information on the forward and backward translation corresponding to the matched information on the link, and then send the translated packet.

The device further includes an extended domain name resolver 85. The extended domain name resolver 85 is arranged to call a core interface to apply to the address mapper 84 for a virtual IPv4 address and return the virtual IPv4 address to the IPv4 client.

The address mapper 84 is specifically arranged to record the mapping relationship between the IPv6 address and the virtual IPv4 address in an IP address mapping table, and send the IP address mapping table to the standard translator 82.

The method disclosed herein is exemplarily described below with reference to an embodiment of the method in a specific scenario.

In the embodiment, based on the realization of the method in an MIFI/CPE-type device (using a linux system), the specific scenario is set to be a scenario in which an intranet terminal PC (IPv4 address: 192.168.0.100) accesses an IPv6 server (domain name: www.ipv6.com, IPv6 address: 2011::30) through an MIFI device (IPv4 address of Intranet: 192.168.0.1, IPv6 address of Extranet: 1:1:1:102b::1). In such scenario, the method for the translation between IPv4 and IPv6 mainly includes the following steps.

In step 901, the MIFI device receives an A-class request for the domain name www.ipv6.com from the intranet terminal. Then, in the step, an extended domain name resolver first forwards the A-class request to a DNS server. If the DNS server returns a response ‘failed’ or fails to return a response, the extended domain name resolver constructs an AAAA-class DNS request and sends the AAAA-class DNS request to the DNS server;

In step 902, after receiving an AAAA-class response, the extended domain name resolver extracts the IPv6 address 2011::30 corresponding to the domain name, and informs an address mapper of the IPv6 address through an interface. The address mapper selects an unused IPv4 address 192.0.0.1 from a virtual IPv4 address pool (192.0.0.1-192.0.255.255), establishes a mapping relationship between the addresses 2011::30 and 192.0.0.1 and synchronously returns the address 192.0.0.1 to the extended domain name resolver. And the extended domain name resolver constructs an A-class DNS response, and returns the A-class DNS response to the intranet terminal.

In step 903, the intranet terminal establishes a TOP link to the virtual address 192.0.0.1, the three packets involved in the TOP three-way handshake are translated through a complete BIH flow. Meanwhile, a BIH link tracker arranged in the MIFI device records the information on the link and the information on the translation.

For a forward packet, that is, a packet sent from an IPv4 client to a linked IPv6 server, is in the procedure POSTROUTING of an IPv4 procedure. The packet first enters the BIH link tracker. In the BIH link tracker, the information on the link of the IPv4 client and information on forward and backward translation of the IPv4 client are extracted but not translated. Then, the packet enters the standard translator. In the standard translator, the packet is translated from an IPv4 packet to an IPv6 packet. Then, the packet enters into an IPv6 processing procedure. In the procedure POSTROUTING of an IPv6 procedure, the packet also first enters the BIH link tracker. In the BIH link tracker, IPv6 link information is extracted, while the packet is synchronously supplemented with the information on the translation, such as a source MAC address, a target MAC address, a port of a source network device and a port of a target network device.

For a backward packet involved in a link establishment process, in the procedure PREROUTING of an IPv6 procedure, the packet first enters the BIH link tracker. In the BIH link tracker, IPv6 link information and the information on the translation are extracted but not translated. Then, the packet enters the standard translator. In the standard translator, the packet is translated from an IPv6 packet to an IPv4 packet. Then, the packet enters into an IPv4 processing procedure. In the procedure POSTROUTING of an IPv4 procedure, the packet also first enters the BIH link tracker. In the BIH link tracker, IPv4 link information is extracted, and meantime, the packet is synchronously supplemented with the information on the translation, such as a source MAC address, a target MAC address, a port of a source network device and a port of a target network device. Then the IPv4 packet is translated to an IPv6 packet, and the IPv6 packet enters into an IPv4 flow and finally sent from the intranet terminal.

In step 904, for a forward IPv4 packet for which a link is established, the forward IPv4 packet enters a quick translator in the MIFI device at a packet receiving port. The quick translator extracts link information for matching, constructs an IPv6 packet directly using the matched information on the forward translation and sends the constructed IPv6 packet from a recorded WAN port.

In step 905, for a backward IPv6 packet for which a link is established, the backward IPv6 packet enters the quick translator in the MIFI device at the packet receiving port. The quick translator extracts link information for matching, constructs an IPv4 packet directly using the matched information on the backward translation and sends the constructed IPv4 packet from a recorded LAN port.

While preferred embodiments of the disclosure have been described above, it should be appreciated that the preferred embodiments are not to be construed as limiting the scope of protection of the disclosure and that any modifications, equivalent substitutes and improvements devised without departing from the spirit and the principle of the disclosure should fall into the scope of protection of the disclosure.

### INDUSTRIAL APPLICABILITY

By recording the information on the link and the information on the translation using an added BIH link tracker, directly translating and sending a subsequent packet using a quick translator if the information on the link of the packet is recorded in the BIH link tracker. As such, the solutions provided herein solve the problem that existing BIH technology is time-consuming in processing and a bit poor in performance.

1. A method for the translation between Internet Protocol version 4 (IPv4) and Internet Protocol version 6 (IPv6), comprising:
providing a Bump in Host (BIH) link tracker and a quick translator in a network core, and when a link is established between an IPv4 client and an IPv6 server, translating, by a standard translator, a packet sent from the IPv4 client to the IPv6 server and sending the translated packet to the IPv6 server, and extracting, by the BIH link tracker, information on the link and translation of the IPv4 client and the IPv6 server from the packet for interaction between the IPv4 client and the IPv6 server and recording the extracted information; and
sending the packet to the quick translator during a process of sending the packet after the establishment of the link between the IPv4 client and the IPv6 server, and translating, by the quick translator, the packet according to the information on the translation corresponding to the information on the link recorded by the BIH link tracker and sending the translated packet.

2. The method for translation according to claim 1, wherein extracting, by the BIH link tracker, information on the link and translation of the IPv4 client and the IPv6 server from the packet for interaction between the IPv4 client and the IPv6 server and recording the extracted information comprises:
when the IPv4 client initiates the establishment of a link to the IPv6 server, receiving, by a translation device, a packet sent from the IPv4 client, sending, by the translation device, the packet to the BIH link tracker when the translation device carries out POSTROUTING for the packet, and extracting, by the BIH link tracker, information on the link of the IPv4 client and information on forward and backward translation of the IPv4 client from the packet and recording the extracted information; and
when the IPv6 server returns a response to the establishment of the link to the IPv4 client, receiving, by the translation device, a packet sent from the IPv6 server, sending, by the translation device, the packet to the BIH link tracker when the translation device carries out PREROUTING for the packet, and extracting, by the BIH link tracker, the information on the link of the IPv6 server and the information on the forward and backward translation of the IPv6 server from the packet and recording the extracted information.

3. The method for translation according to claim 2, wherein sending the packet to the quick translator during a process of sending the packet after the establishment of the link between the IPv4 client and the IPv6 server comprises:
after the link is established between the IPv4 client and the IPv6 server, sending, by the translation device, the packet to the quick translator before the translation device carries out PREROUTING for the packet.

4. The method for translation according to claim 1, wherein translating, by the quick translator, the packet according to the information on the translation corresponding to the information on the link recorded by the BIH link tracker and sending the translated packet comprises:
extracting, by the quick translator, the information on the link of the IPv4 client from the packet and matching the information on the link with the information on the link recorded by the BIH link tracker, when the matching is succeeded, translating, by the quick translator, the packet from an IPv4 type to an IPv6 type according to the information on the forward and backward translation corresponding to the matched information on the link and sending the translated packet to the IPv6 server.

5. The method for translation according to claim 1, further comprising: constructing, by an extended domain name resolver, an AAAA-class domain name service (DNS) request for a domain name when an A-class DNS request for the domain name is failed, calling, by the extended domain name resolver, a core interface after an IPv6 address is obtained, applying, by the extended domain name resolver, to the address mapper for a virtual IPv4 address, returning, by the extended domain name resolver, the virtual IPv4 address to the IPv4 client, and recording, by an address mapper, the mapping relationship between the IPv6 address and the virtual IPv4 address in an IP address mapping table and sending the IP address mapping table to the standard translator.

6. A device for the translation between IPv4 and IPv6, comprising: a BIH link tracker, a standard translator and a quick translator, wherein
the BIH link tracker is arranged to extract, when a link is established between an IPv4 client and an IPv6 server, information on the link and translation of the IPv4 client and the IPv6 server from the packet for interaction between the IPv4 client and the IPv6 server and record the extracted information;
the standard translator is arranged to translate a packet sent from the IPv4 client to the IPv6 server and send the translated packet to the IPv6 server; and
the quick translator is arranged to translate, during a process of sending the packet after the establishment of the link between the IPv4 client and the IPv6 server, a packet according to the information on the translation corresponding to the information on the link recorded by the BIH link tracker and send the translated packet.

7. The device for translation according to claim 6, wherein when the IPv4client initiates the establishment of a link to the IPv6 server, the BIH link tracker is arranged to, when carrying out POSTROUTING for the packet sent from the IPv4 client, extract, from a packet sent from the IPv4 client, information on the link of the IPv4 client and information on forward and backward translation of the IPv4 client and record the extracted information;
when the IPv6 server returns a response to the establishment of the link to the IPv4 client, the BIH link tracker is arranged to, when carrying out PREROUTING for the packet sent from the IPv6 server, extract, from a packet sent from the IPv6 server, information on the link of the IPv6 server and the information on the forward and backward translation of the IPv6 server and record the extracted information.

8. The device for translation according to claim 6, wherein
the quick translator is arranged to: extract the information on the link of the IPv4 client from a packet, match the information on the link with the information on the link recorded by the BIH link tracker and, when the matching is succeeded, translate the packet from an IPv4 type to an IPv6 type according to the information on the forward and backward translation corresponding to the matched information on the link and send the translated packet to the IPv6 server.

9. The device for translation according to claim 6, further comprising: an address mapper arranged to send an IP address mapping table to the standard translator, wherein
the standard translator is arranged to translate, according to the IP address mapping table sent from the address mapper, a packet from an IPv4 networktype to an IPv6 network type and send the translated packet to the IPv6 server.

10. The device for translation according to claim 9, further comprising: an extended domain name resolver arranged to construct an AAAA-class domain name service (DNS) request for a domain name, call a core interface after obtaining an IPv6 address, apply to the address mapper for a virtual IPv4 address and return the virtual IPv4 address to the IPv4 client, wherein
the address mapper is arranged to record the mapping relationship between the IPv6 address and the virtual IPv4 address in an IP address mapping table and send the IP address mapping table to the standard translator.

11. The method for translation according to claim 1, wherein translating, by the quick translator, the packet according to the information on the translation corresponding to the information on the link recorded by the BIH link tracker and sending the translated packet comprises:
extracting, by the quick translator, the information on the link of the IPv6 server from the packet and matching the information on the link with the information on the link recorded by the BIH link tracker, when the matching is succeeded, translating, by the quick translator, the packet from an IPv6 type to an IPv4 type according to the information on the forward and backward translation corresponding to the matched information on the link and sending the translated packet to the IPv4 client.

12. The device for translation according to claim 6, wherein the quick translator is arranged to extract the information on the link of the IPv6 server from the packet, match the information on the link with the information on the link recorded by the BIH link tracker and, when the matching is succeeded, translate the packet from an IPv6 type to an IPv4 type according to the information on the forward and backward translation corresponding to the matched information on the link and send the translated packet to the IPv4 client.
